(19) United States
(12) Patent Application Publication
(10) Pub. No.: US 2018/0151051 A1
(43) Pub. Date: May 31, 2018

(54) Roof Joist Displacement sensor & active filter circuit

(71) Applicant: Christopher Collings, Marion, MA (US)

(72) Inventor: Christopher Collings, Marion, MA (US)

(21) Appl. No.: 15/364,599

(22) Filed: Nov. 30, 2016

(51) Int. Cl. G08B 21/18; G01G 23/36; G08B 13/184; G08B 13/19; E04B 7/18; E04B 1/92

(52) U.S. Cl. CPC G08B 21/182; G01G 23/36; G08B 13/184; E04D 13/00; E04B 7/18; E04B 1/92; G08B 13/19

(57) ABSTRACT

Wintertime precipitation (snow, Ice, rain over snow) cause more than 89% of structural failures in the US each year*. Insurance industry estimates losses exceed $2 Billion USD each year. These estimates do not include “soft costs” like lost business days or revenue. ASCE Snow Induced Building Failures Report-August 2012

Roof snow removal is a labor intensive & hazardous operation. Best practices mandate fall protection and careful operational supervision both on the roof and at ground level. The cost to a building owner can range widely depending on the conditions and the type of building and its unique features.

With cost ranging from $1.00 to $3.00 per square foot, a reliable and accurate system for measuring roof loading will give property managers a way to safely and effectively manage snow load monitoring and removal.

### STATEMENT OF THE INVENTION

This invention is an improvement over a previous roof deflection monitoring system (U.S. Pat. No. 5,404,132). Roof support structures deflect in response to accumulating “Live Loads” on a roof. Such loads being the weight of snow, ice, water as it collects on a roof. The improvement claimed in this invention is the ability to differentiate between IR laser beam interruptions due to live load deflection (displacement of joist/purlin from accumulating loads) and the temporary interruptions caused by foreign objects or vibration This differentiation is achieved by the introduction of a programmable time filter (variable time adjustment) to the sensor triggering circuit. This gives the monitoring device the ability to disregard intermittent IR beam interruptions.

The elimination of such spurious alert notifications and false alarms improves the reliability of the deflection alarm systems and makes a laser based roof joist deflection alarm system user friendly for maintenance personnel and building security officials.

### BACKGROUND OF THE INVENTION

### Prior Art

Utility patent U.S. Pat. No. 5,404,132-Canty, Jeffery N & Canty Charles W*. uses an IR laser beam projected between opposing end walls of a joist bay. The IR laser beam emitter is aimed at its receiving sensor. When the roof joists deflect to a predetermined amount - calibrated blocking targets mounted on individual roof support members interrupt the laser beam and create an alarm notification at a central control panel. Utility U.S. Pat. No. 5404132

Deficiencies of Prior Art

As originally designed and patented—the Canty designed Roof Deflection system utilizes an Infra Red emitter & receiver connected to an addressable monitoring module (common fire alarm component). This original detection circuit is “indiscriminate” in that any interruption of the infrared beam, whether by roof deflection itself or by building vibration or foreign objects turning up in the path of the IR beam, creates an alarm notification.

Because the circuit is “indiscriminate”, it is sensitive to non-deflection related laser beam interruptions caused when loose material or other foreign objects temporarily block the line of sight between the IR emitter & it's dedicated receiver. These types of IR beam interruptions cause false alarm notifications at the control panel that detract from the ability of the system to reliably identify excessive roof-loading induced joist deflection.

### DETAILED DESCRIPTION

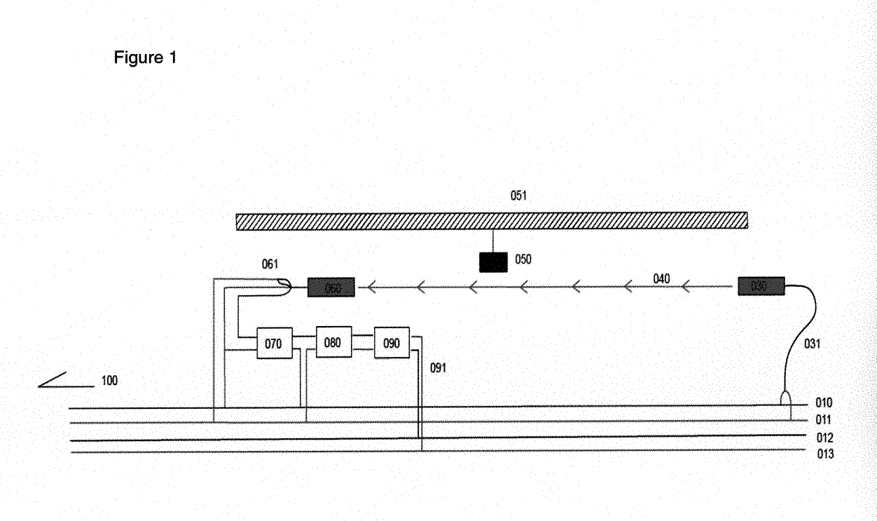

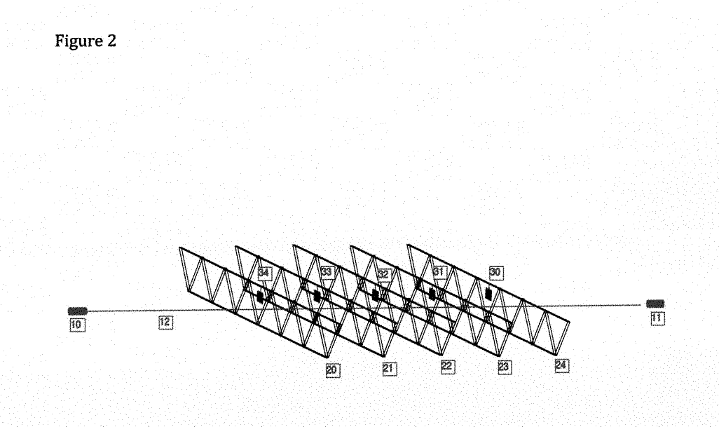

Claimed in this invention is the use of a time-based filter in the IR sensor circuit as shown in FIG. 1 and installed as indicated in FIG. 2. The most common false alarm sensor interruptions are momentary events lasting between 1 second and 5 minutes. Typically these interruptions are caused by building vibration, loose debris, building components (ie. un-secured power cable, wiring conduit, lighting fixtures, etc), birds, etc. periodically interrupt the IR laser beam. The system described in this invention is not triggered by these temporary interruptions. Eliminating these common forms of false alarm activity improves the reliability and functionality of the IR joist deflection sensor system.

Working Description

Reference FIG. 1 & FIG. 1 Drawing Key

Figure one describes the components and functions of the time filter equipped joist displacement sensor.

The displacement sensor system reports an alarm condition when the Joist Deflection target (drawing feature 50) interrupts the Infra Red beam (drawing feature 40) that is projected between the emitter (feature 30) and the Infra Red receiver (feature 60).

The receiver (Feature 60) is triggered by any interruption of the projected IR beam from the Emitter (feature 30). In order to prevent repeat and unneeded false reports caused by temporary interruptions of the projected Infra Red beam, a pair of relay circuits are included (features 70 & 80). When the Sensor (60) is initially triggered—it will cause the first relay (70) to initiate the timed relay circuit (80). When the programmed time expires—relay circuit (80) triggers the supervised monitoring module (drawing feature 90) to send an alarm signal to the central control panel.

In order to trigger an alarm notification from the monitoring module (90)—the IR beam must be blocked for more than the programmed time setting in the timer circuit (80). The timer resets each the IR beam is re-established, so building vibration and loose material that temporarily blocks the IR beam path does not trigger an alarm report from the monitoring module (90)

Reference FIG. 2 & FIG. 2 Drawing Key

FIG. 2 is a perspective view drawing, illustrating how the sensor, receiver, and deflection targets are installed under roof joists. Note the sensors (drawing features 10 & 11) are aligned along the center of the joist span (drawing features 20-24) and mounted at opposite ends of a roof section. The deflection targets (drawing features 30-34) mounted on individual bar joists in line with the projected IR sight line. The deflection alarm circuit is triggered when deflection targets interrupt the IR sensor sight line.

FIG. 1—Timer Equipped Joist Displacement Alarm Circuit

FIG. 1 Drawing Key

FIG. 1 DRAWING KEY—Infra-Red Joist displacement detection
system w/timer delay

| Drawing | |
|---|---|
| feature | discription |
| 10 | Field wire—BLACK = 24 VDC negative power |
| 11 | Field wire—RED = 24 VDC positive power |
| 12 | Field wire—DATA—negative VDC |
| 13 | Field wire—DATA—positive VDC |
| 30 | Infra-red emitter device |
| 31 | IR connection to held wiring |
| 40 | Infra-red sensor “sight line” |
| 50 | Joist deflection target—Target blocks IR signal when joist |
| | deflects to pre-set limit |
| 51 | Roof joist or Purlin—Deflection target is placed at 50% of |
| | total length |
| 60 | Infra-red receiver—sensor has definition in excess of 1/100″ |
| | allowing for accurate joist deflection measurement |
| 61 | IR reciver connection to field wire & timer circuit |
| 70 | Relay circuit powered by IR receiver—relay loses power |
| | when IR receiver is blocked by sagging joist |
| 80 | Timer curcuit—timer is activated when relay circuit losses |
| | power |
| 90 | Supervised & addressed status monitoring module—reports |
| | operating status (normal or alarm) to control panel every 5 |
| | seconds |
| 91 | Wire connection of module to DATA connection in field |
| | wire |
| 100 | Field wire connects all Joist Displacement detection devices |
| | to UL listed programmable control panel |

FIG. 2—Sensor Installation Example—3D Perspective View

FIG. 2 Drawing Key

10—IR Sensor

11—IR Emitter

12—Projected sensor sight line

2-24 roof supporting bar joists (perspective view)

30-34 Calibrated deflection targets mounted to each bar joist

Foot Notes

ASCE Snow Induced Building Failures Report-August 2012

Utility U.S. Pat. No. 5404132

1) I claim an automatic alarm system for identifying the displacement (deflection) of roof structures (bar joists, purlins, I-beams, solid wooden beams, and trusses) caused when LIVE LOAD weight (SNOW, ICE, and/or water) accumulates on a roof surface.

2) Building on claim 1, it is further claimed, the alarm system includes a photo Electric Infra Red (IR) emitter, mounted so that it projects an IR laser along a path in line with the centerline (50% of span) of roof supporting structures (bar joists, purlins, I beams, solid wooden beams, and trusses)

3) Building on claim 1, it is further claimed, the alarm system has a Photo electric IR receiver mounted opposite the emitter and aligned in a similar manner, in line with the centerline of the roof supporting structures.

4) Building on claims 1, 2, & 3, further claim that Deflection target(s) are mounted to the individual roof supports (bar joists, Purlins, I beams, solid wooden beams, and trusses) in line with the Emitter & receiver and positioned as to block the projected Infra Red signal when roof supporting joists with attached targets are displaced (deflected) by accumulating loads.

5) Building on claim 1, it is further claimed that a Two stage relay circuit is connected to the Infra Red receiver and providing a programmable time delay for the purpose of preventing intermittent interruptions of the Infra Red signal—caused by building vibration, loose material acting as a block to the IR laser, or other forms of temporary blockages.
